(19) United States
(12) Patent Application Publication
(10) Pub. No.: US 2010/0289285 A1
(43) Pub. Date: Nov. 18, 2010

(54) APPARATUS FOR MANIPULATING PIPES

(76) Inventors: Frederik Stoldt, Hamburg (DE); Jens Baier, Hamburg (DE)

Correspondence Address: LUCAS & MERCANTI, LLP, 475 PARK AVENUE SOUTH, 15TH FLOOR, NEW YORK, NY, 10016, US

(21) Appl. No.: 12/762,200

(22) Filed: Apr. 16, 2010

(30) Foreign Application Priority Data
Apr. 16, 2009 (DE) 10 2009 019 007.4

(51) Int. Cl. B66C 1/62

(52) U.S. Cl. 294/88

(57) ABSTRACT

An apparatus for manipulating pipes has a base component and a counter element pivotally mounted relative to the base component. The base component and the counter element together define in a closed state thereof a recess for receiving the pipes. The base component and the counter element are connectable through at least one pivot joint and at least one locking member. At least one hydraulic drive is provided for positioning the counter element relative to the base component. A mechanical locking device in addition to the closing member connects the base component and the counter element with each other.

### BACKGROUND OF THE INVENTION

1. Field of the Invention

The present invention relates to an apparatus for manipulating pipes, wherein the apparatus has a base component as well as a counter element which is pivotably arranged relative to the base component, wherein the base component and the counter element together form in the closed state thereof a recess for receiving the pipes, and wherein the base component and the counter element are connectable by at least one pivoting joint and at least one locking member.

2. Description of the Related Art

Apparatuses of the above-described type are usually used as “single joint elevator” and serve for receiving, lifting and depositing individual pipe segments. The pipe segments are typically arranged in the vicinity of oil drilling platforms and serve for defining a bore hole and/or are used for conveying crude oil.

Such an apparatus typically is composed of two halves which in a rear portion are connected through a hinge bolt. Provided at the front side is a locking member which is capable of connecting the two halves.

The known apparatuses are still not constructed in such a way that it can be excluded with sufficient certainty that a manipulation of pipes would be prevented in the event that the locking member of the two halves of the apparatus is locked incorrectly or that an unintentional opening of the closing member is excluded in the case of a load acting on the apparatus.

### SUMMARY OF THE INVENTION

Therefore, it is the object of the present invention to further develop an apparatus of the above-described type in such a way that the safety of manipulation is improved.

In accordance with the present invention, this object is met by constructing the counter element so as to be positionable relative to the base component by means of at least one hydraulic drive, wherein, in addition to the closing member, a mechanical locking means connects the base element and the counter element to each other.

By using the hydraulic drive, an opening and closing of the elevator takes place. As soon as the elevator and the closing member are closed completely, a signal is generated for the operator in order to indicate that it is possible to start to pick up loads. The additional mechanical locking means increases the safety because even in the case of a failure of the hydraulic drive an opening of the elevator under load is prevented.

An opening of the mechanical locking means is only possible if no load acts upon the apparatus and, thus, there are no pipes to be manipulated being held by the apparatus.

A high mechanical load bearing capacity is achieved if the locking member makes available a positively engaging connection between the base component and the counter element.

High adjusting forces can be achieved by constructing the hydraulical drive as at least one hydraulic cylinder.

A safe closing function can be supported by actuating the closing member by at least one hydraulic cylinder.

In order to facilitate the operation, it is provided that at least one indicating device for a closing position is used.

A simple detection of a closing position can be effected by coupling the indicating device with a sensor which is constructed as a valve.

Another increase of the operating safety is effected by making the mechanical locking element lockable by means of the pipe held by the apparatus.

In particular, it is intended that the mechanical locking element is blocked against opening during a manipulation of pipes by the pipe being held.

A long operational capability is supported by protecting at least one hydraulic structural element by at least one mechanical protection device.

An advantageous geometric configuration resides in that the base component and the counter element are each formed similar to semi-circular clamps.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE DRAWING

In the drawing:

FIG. 1 is a perspective view of the apparatus according to the present invention in a closed state;

FIG. 2 is an illustration similar to FIG. 1 shown in an open state of the apparatus;

FIG. 3 is a top view as seen in the direction of arrow III in FIG. 2;

FIG. 4 is a top view as seen in the direction of arrow IV in FIG. 1;

FIG. 5 is a perspective view as seen in the direction of arrow V in FIG. 1;

FIG. 6 is an enlarged illustration of the detail VI in FIG. 1; and

FIG. 7 is an illustration similar to FIG. 6 with the safety stirrups being removed.

### DETAILED DESCRIPTION OF PREFERRED EMBODIMENTS

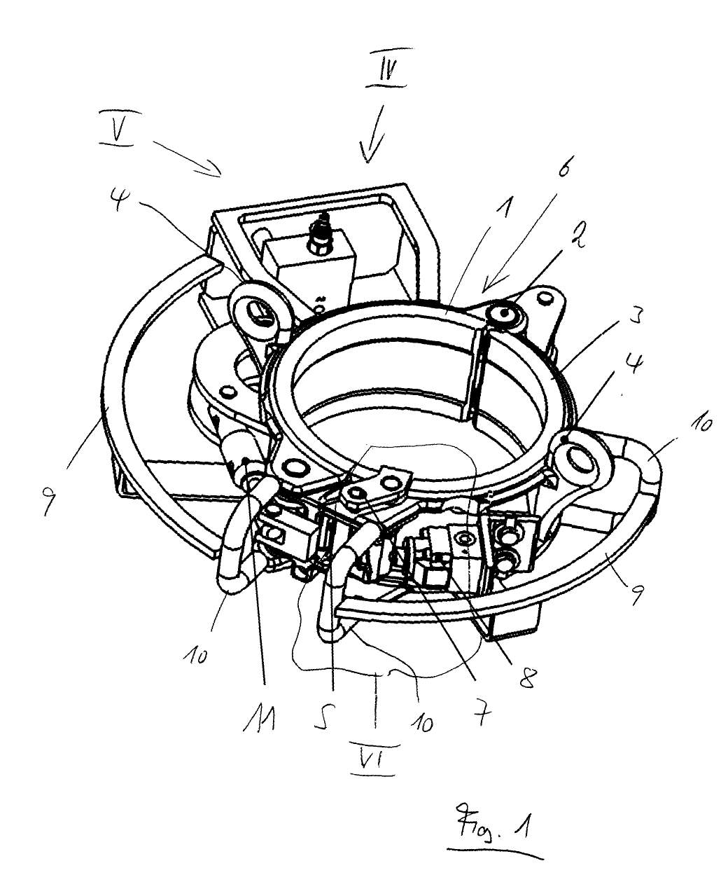

FIG. 1 shows a perspective view of an apparatus for manipulating pipes, not shown. The apparatus includes a base component 1 which is connected by a pivoting joint 2 to a counter element 3. The pivoting joint 2 is typically provided in the form of a hinge bolt. In a top view, the base component 1 and the counter element 3 each have a contour which is similar to a semi-circular clamp.

Although the base component 1 as well as the pivot joint 2 are provided with at least one stop element 4 which is constructed in the form of an eye and serves for connecting the apparatus to a lifting device, not shown. In addition to the connection through the pivot joint 2, the base component 1 and the counter element 3 are connected to each other through a closing member 5 which connects the base component 2 and the counter element 3 mechanically with each other.

Positioning of the counter element 3 relative to the base component 1 takes place with the use of a hydraulic drive 11 which, in FIG. 1, is covered by the base component 1. A hydraulic cylinder can be used as the hydraulic drive 6. The closing device is positioned by a hydraulic closing cylinder 6.

In addition to the closing member 5, the apparatus includes a mechanical locking element 7. A valve 8 for detecting the position is constructed preferably as a two/two way valve.

For ensuring a protection of the device relative to any mechanical forces, it is preferably provided that the base component 1 as well as the counter element 3 are equipped with protective stirrups 9, 10. The protective stirrups 9, 10 take over the function of an impact protection.

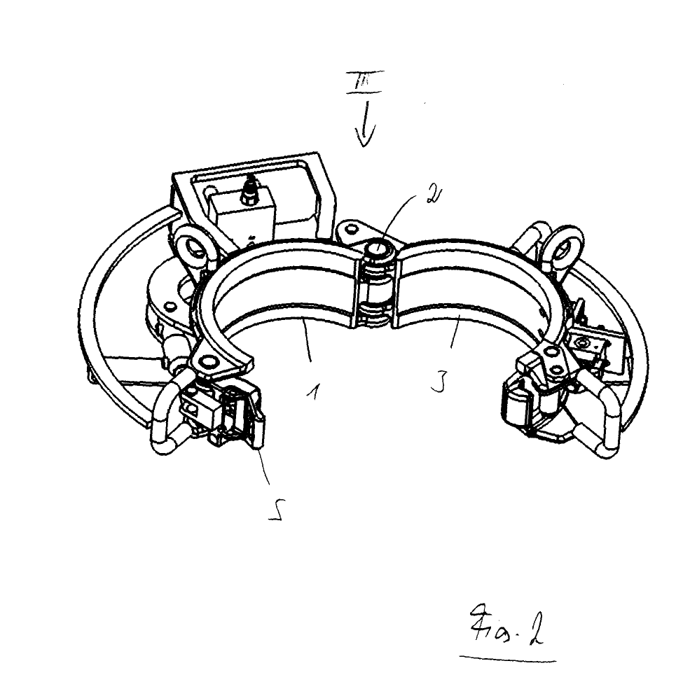

FIG. 2 shows the apparatus of FIG. 1 in an open state. The mechanical locking device 7 as well as the closing element 5 are open and the counter element 3 is pivoted around the pivot joint 2. The apparatus can in this state be pushed laterally over a pipe to be manipulated.

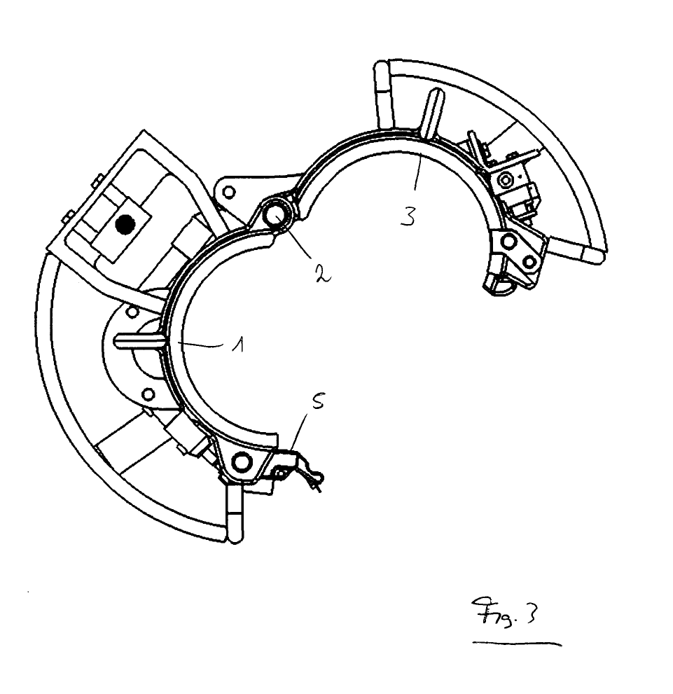

FIG. 3 shows the apparatus of FIG. 2 in a top view in an open state. The drawing particularly shows in this connection the large opening area which serves for receiving the pipe to be manipulated.

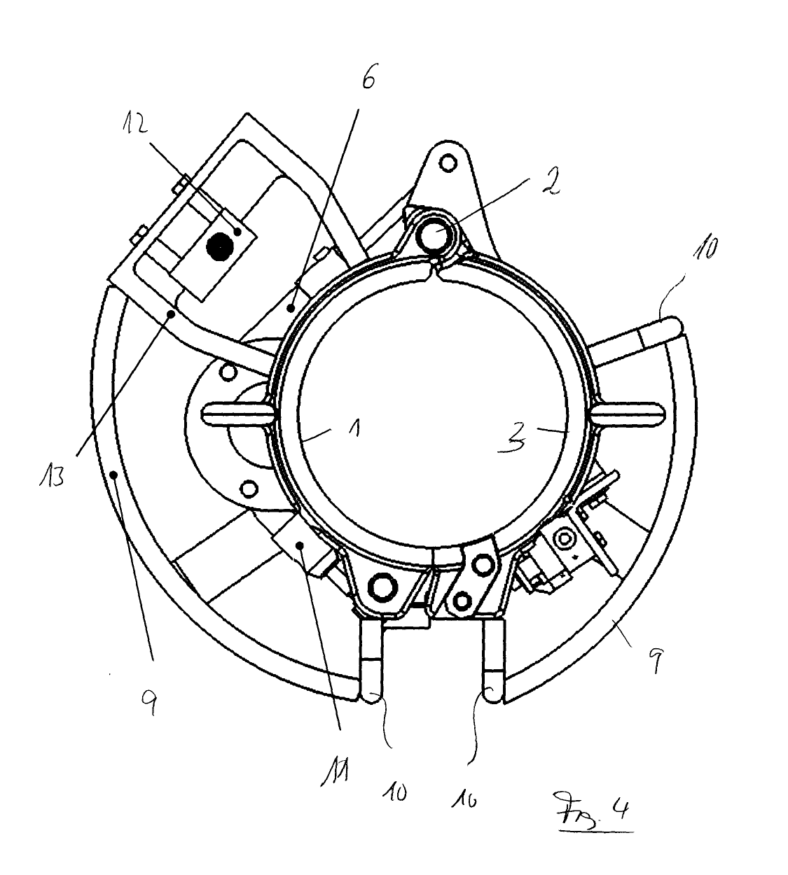

FIG. 4 shows in a top view the hydraulic components being used. The hydraulic drive 6 serves as a closing cylinder. In addition, a housing cylinder 11 can be seen. A hydraulic supply takes place with the use of a hydraulic block 12. the hydraulic block 12 is used in a cage 13 for protecting against mechanical damage.

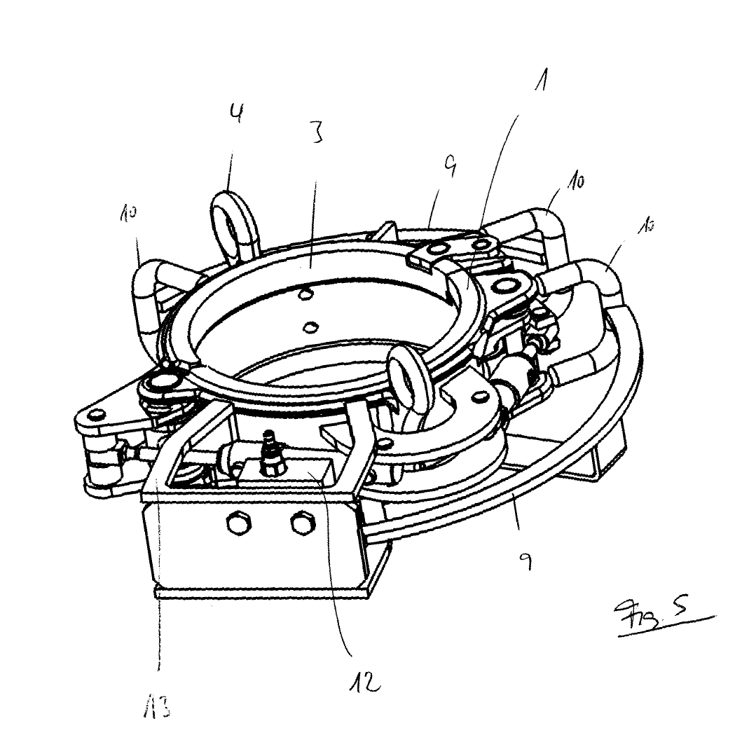

FIG. 5 shows the apparatus in a closed state of operation in a perspective direction of view from behind onto the hydraulic block 12. This illustration once again illustrates in particular the fact that all mechanical sensitive components are protected by the protective stirrups 9, 10 or by the cage 13.

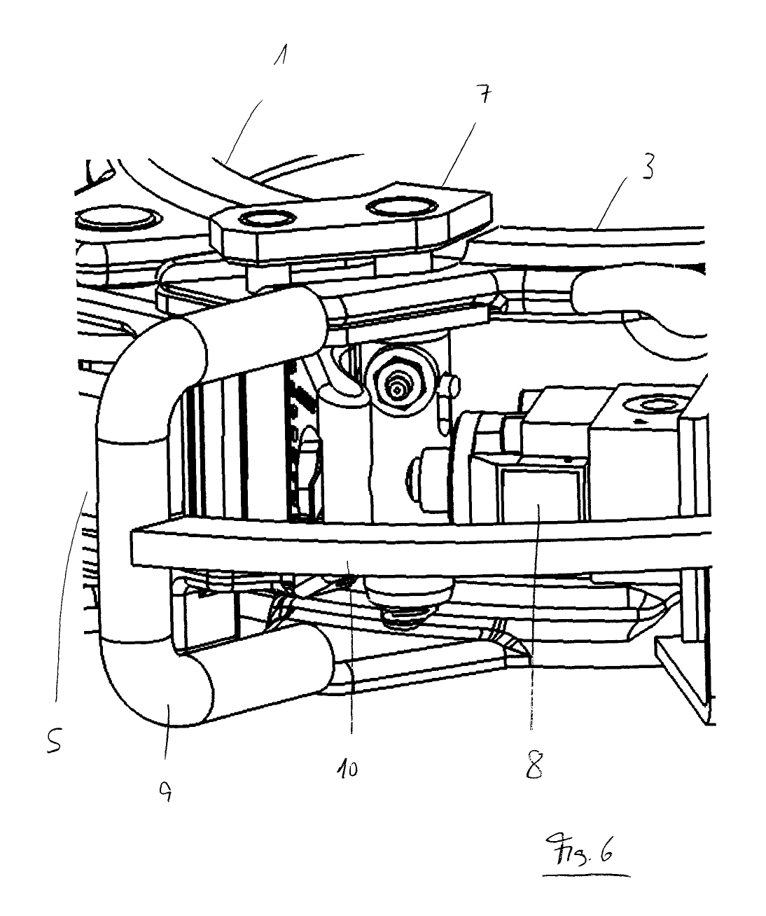

FIG. 6 illustrates in a significantly enlarged illustration the arrangement of the closing element 5, the mechanical locking means 7 as well as the valve 8.

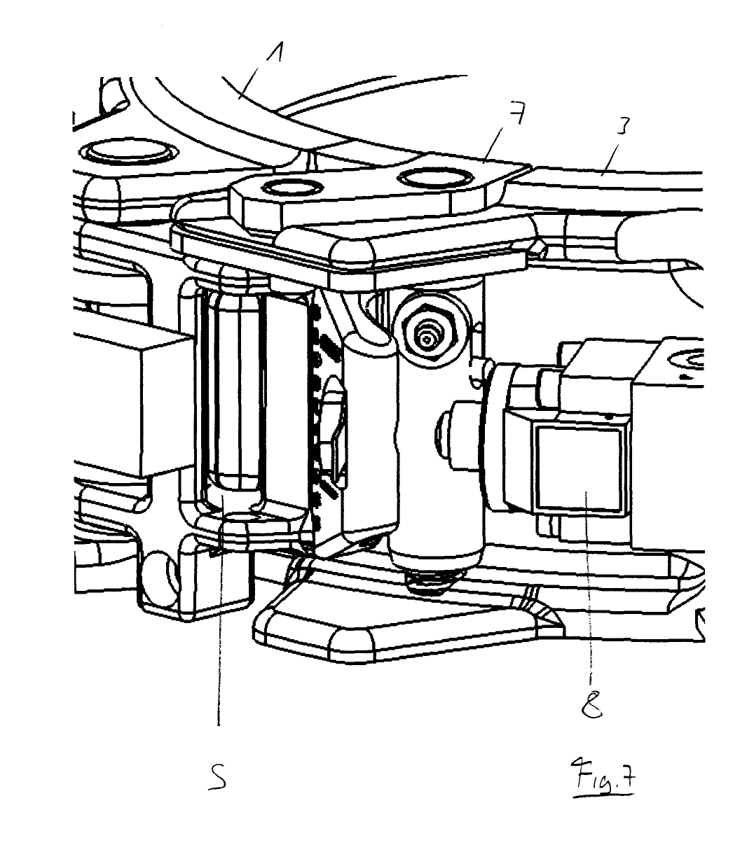

FIG. 7 shows the arrangement according to FIG. 6 after the removal of the protective stirrups 9, 10.

A typical configuration of the apparatus serves for manipulating a payload of 5 sht. Opening and closing of the apparatus takes place with the use of at least one hydraulic cylinder 11. A back coupling signal is generated in a completely closed elevator and is generated by a completely closed closing element 5. When a load is picked up, an additional mechanical locking takes place.

The hydraulic control block 12 makes it possible to realize a compact construction. The hydraulic control block 12 has a pressure sequence valve and a check valve. All hydraulic components are protected relative to load impact by mechanical elements. The displacement speed of the hydraulic cylinders are adjustable by means of manual throttle check valves. A release position of the back coupling signal for actuating a correct locking action can be predetermined by the use of an adjusting screw. All components being used are balanced along a circumference of the apparatus in order to support an optimum manipulation.

The functional sequence in the use of the apparatus is now explained in more detail below.

After a manipulation of a pipe, the mechanical locking means 7 must be without a load because otherwise it could not be opened. Typically, the apparatus is coupled in a closed state with the use of stop elements 4 to a lifting device, for example, with the use of chains. The hydraulic elements are then connected to supplies with the use of hydraulic quick-action couplings. The quick-action couplings preferably have different connection sizes in order to prevent mix-ups.

An operator then starts the opening procedure by an operating element. In this connection, a hydraulic pressure is built up in the area of the closing cylinder 6 and the closing cylinder 6 opens the assigned closing member 5. Simultaneously, the pressure in the housing cylinder 11 rises in the side of the piston rod. The housing cylinder 11 generates a force which may result in the opening of the apparatus. However, the opening movement can only be started after the closing element 5 has been opened.

After opening the apparatus, the pipe to be manipulated is picked up and the operator subsequently effects a control command for closing the apparatus. Subsequently, a pressure is released in the area of the bottom side of the housing cylinder 11 and the apparatus closes around the pipe. After the pressure has been completely built up, the pressure sequence valve switches. A pressure is then generated against the piston bottom side of the closing cylinder 6 and the closing member 5 is transferred into the closed position. Subsequently, a return signal is generated in the area of a two/two way valve which signals the actuation of the closing member. The apparatus can then be lifted with the pipe.

As a result of the force acting from the pipe to be manipulated on the pipe, an additional mechanical locking effect of the closing member is created.

While specific embodiments of the invention have been shown and described in detail to illustrate the inventive principles, it will be understood that the invention may be embodied otherwise without departing from such principles.

1. An apparatus for manipulating pipes, wherein the apparatus has a base component and a counter element pivotally mounted relative to the base component, wherein the base component and the counter element together define in a closed state thereof a recess for receiving the pipes, and wherein the base component and the counter element are connectable through at least one pivot joint and at least one locking member, the apparatus further comprising at least one hydraulic drive for positioning the counter element relative to the base component, and a mechanical locking means in addition to the closing member for connecting the base component and the counter element with each other.

2. The apparatus according to claim 1, wherein the closing member is configured to provide a positively engaging connection between the base component and the counter element.

3. The apparatus according to claim 1, wherein the hydraulic drive is comprised of at least one hydraulic cylinder.

4. The apparatus according to claim 1, wherein the closing member is actuated by at least one hydraulic cylinder.

5. The apparatus according to claim 1, wherein at least one indicating device comprises a closing means position.

6. The apparatus according to claim 5, wherein the indicator is coupled to a sensor constructed as a valve.

7. The apparatus according to claim 1, wherein the mechanical locking means is lockable by the pipe held by the apparatus.

8. The apparatus according to claim 1, wherein the mechanical locking means is blocked by the supported pipe relative to opening during manipulation of pipes.

9. The apparatus according to claim 1, wherein at least one hydraulic structural element is protected by at least one mechanical protection device.

10. The apparatus according to claim 1, wherein the base component and the counter element are each constructed similarly as semi-circular clamps.
